(19) United States
(12) Patent Application Publication
(10) Pub. No.: US 2018/0272792 A1
(43) Pub. Date: Sep. 27, 2018

(54) USE OF ELEMENTS FOR WRITING, DRAWING, MARKING, AND/OR PAINTING DEVICES, OR COSMETIC DEVICES, OR INPUT DEVICES

(71) Applicant: STAEDTLER MARS GMBH & CO. KG, NÜRNBERG (DE)

(72) Inventor: Klaus FISCHBÄCK, Nürnberg (DE)

(21) Appl. No.: 15/765,008

(22) PCT Filed: Sep. 30, 2016
(86) PCT No.: PCT/EP2016/001629

§ 371 Date: Mar. 30, 2018

(30) Foreign Application Priority Data
Oct. 5, 2015 (DE) 10 2015 012 940.6

(51) Int. Cl. B43K 5/00; B43K 7/00; B43K 8/00; B33Y 80/00

(52) U.S. Cl. CPC B43K 5/005; B43K 7/005; B29C 64/10; B33Y 80/00; B43K 8/003

(57) ABSTRACT

The use of an element for a writing, drawing, marking, and/or painting device, or cosmetic device, or input device for touch-sensitive surfaces, wherein the at least one element is a 3D-printed element. The at least one element has at least one main body and at least one structure. The at least one main body consists of a first material component. The at least one structure is provided as a visually detectable structure and/or at least one structure formed as a haptic zone. The at least one visually detectable structure and/or at least one structure formed as a haptic zone is a raised structure which projects from the surface, or the at least one visually detectable structure and/or at least one structure formed as a haptic zone is a decorated zone of the surface.

The invention relates to the use of elements for writing, drawing, marking and/or painting devices or cosmetic devices or input devices for touch-sensitive surfaces, wherein the elements are produced by means of 3D printing.

Components for such devices are known in principle.

Here mention may be made of components such as shafts or caps for writing, drawing, marking and/or painting devices whose main body is produced by extrusion and which have a constant cross-sectional profile over the entire length. The cross-sectional profiles can differ substantially from one another or be differently configured in terms of their geometries.

It should be seen to be disadvantageous here that deviations in the geometry and surface design, perpendicular to the extrusion direction such as for example indentations and/or elevated structures are not possible in a continuous process with such a method of manufacture. At least one additional process or working step is required to create such structures. Furthermore, it should be seen as disadvantageous that an individualization/personalization or individual design of the look and surface is not possible here in a simple manner.

Furthermore, it is possible to produce components for writing devices in the injection molding process. Here it is possible to produce or image the elements with raised but also recessed structures. It should be seen as a disadvantage here that injection molds are very expensive, in particular when products are to be made from several material components (2-K). Furthermore, it should be seen as disadvantageous that as a result of expensive molds, no individualizability is given in cases of small numbers of items. For example, a haptic design tailored to a person is not possible.

Components such as for example shafts are known from DE 102010030539 A1, where these components have elevated structures, wherein these structures are formed in one piece with the component. Here the surface of the component is heated with a laser which has the result that the heated plastic emerges from the surface of the component accompanying a change in the volume size. A disadvantage is that the described method requires a high energy expenditure and in addition is difficult to control. Each individual structure which is to be produced must be individually controlled. Furthermore, the energy input due to the laser beam is too high in some cases, with the result that partial combustions can occur on the component. In this highly technical expensive method, there is certainly a possibility for individualization in a certain sense but all modifications to the components are based on the base material of the component.

Components are further known which are produced in the corrugation process. This is understood as the subsequent treatment of an extruded strand using a so-called corrugator. Such a process is known for example from DE 102010056239 A1 for plastic tubes. In the process a freshly extruded strand of plastic is drawn into a corrugator in which the strand then runs through shaping jaws of the corrugator and a corrugated structure is formed according to the configuration of the shaping jaws. The plastic strand is thereby pressed into the cavities of the shaping jaws. This can for example be achieved or assisted by vacuum. It should be seen as disadvantageous here that no individualizability of the produced components is thus achieved. This is a costly process for creating large numbers of identical parts.

It is the object of the invention to provide elements for writing, drawing, marking and/or painting devices or cosmetic devices or input device for touch-sensitive surfaces, wherein the elements do not have the said disadvantages and wherein the elements in particular should have a haptically advantageous and/or decoratively configured surface.

It is further the object of the invention that the elements can be individually configured.

This object is solved with the features of the main claim. Advantageous configurations are covered by the features of the subclaims.

The object is solved by the use of at least one element for writing, drawing, marking and/or painting devices or cosmetic devices or input devices for touch-sensitive surfaces. The at least one element is configured as a 3D-printed element, wherein the at least one element comprises at least one main body and at least one structure. The at least one main body consists of a first material component, in which the at least one structure is provided as a visually detectable structure and/or at least one structure formed as a haptic zone. The at least one visually detectable structure and/or at least one structure formed as a haptic zone is configured as an indentation or recess in the surface. The at least one visually detectable structure and/or at least one structure formed as a haptic zone can be configured as a raised structure which projects from the surface. The at least one visually detectable structure and/or at least one structure formed as a haptic zone can be configured as a coloured and/or functionally decorated region of the surface.

The raised structure and/or the decorated region is formed in one piece with the at least one main body which means that the main body and the structure consist of the first material component. Alternatively, the raised structure and/or the decorated region can be formed from an at least second material component.

Haptic zones produce a pleasant feeling during handling for the user and prevent for example fatigue effects during writing for a fairly long time.

It has proved to be advantageous if visually detectable and/or haptic zones are designed or individually designed without a separate or additional manufacturing process needing to be used in addition to the 3D printing process.

The following methods can be used in 3D printing. Scan LED technology (SLT), multijet modelling (MJM), selective laser sintering (SLS), polyjet technology (PJ), stereo-lithography (SLA), vacuum casting, selective laser melting (SLM) and fused deposition modelling (FDM).

It can also be deemed to be advantageous in 3D printing processes that in addition to the printing of complete elements from one material component, elements consisting of two or more material components can also be produced. A first material component differs from a second or further material component in colour and/or composition.

Individual designs of elements which have been produced by means of 3D printing include, for example, structures such as signatures or lettering, pictorial diagrams and/or geometries of all kinds regardless of whether these are configured as raised structures, indentations, recesses and/or decorations.

The at least one visually detectable structure and/or at least one structure configured as a haptic and/or anti-slip region is frequently connected to the at least one main body in one piece, which means that main body and structure consist of a first material component.

Alternatively, the at least one visually detectable structure and/or at least one structure configured as a haptic and/or anti-slip region can be configured as a second or further material component.

For example, the first and/or at least second material component can consist of PLA, ABS, Nylon, rubber-like materials, resins and PP.

The use of an element according to the invention is described in detail with reference to the following figures and preferred exemplary embodiments are shown are described.

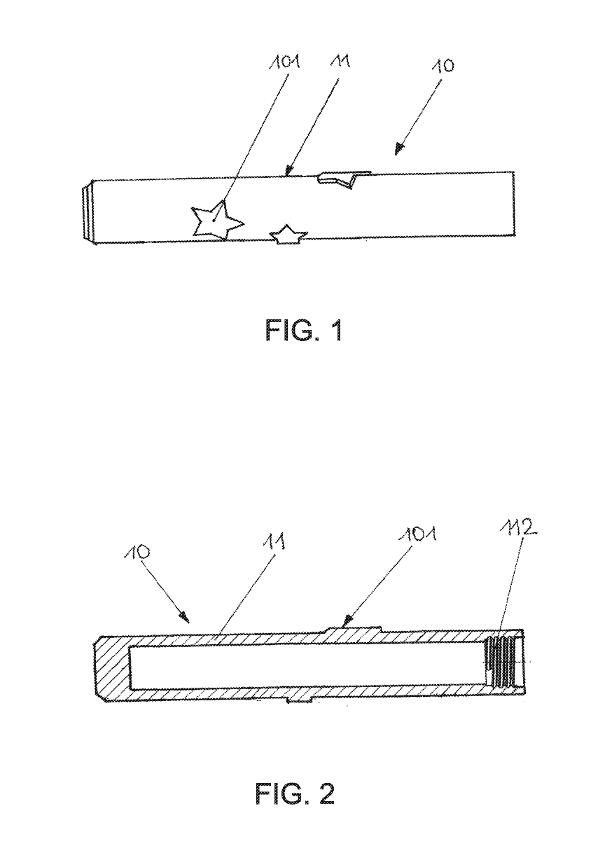

FIG. 1: shows a plan view of an element intended for a use according to the invention.

FIG. 2: shows a longitudinal section through the element according to FIG. 1.

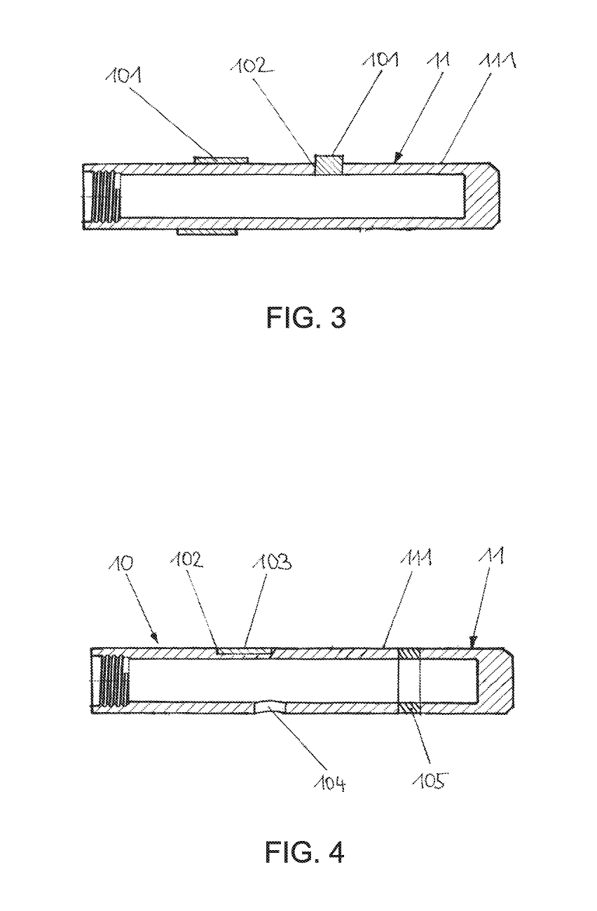

FIG. 3: shows a longitudinal section through a shaft element with raised structures made of a second material component.

FIG. 4: shows a shaft in longitudinal section with decorative elements, indentations and recess.

FIG. 1 shows a plan view of an element 10 for the use according to the invention in a writing, drawing, marking and/or painting device or cosmetic device or input device (1). The element 10 is here configured as a shaft element 11 as main body. Raised structures 101 are formed on the shaft element 11, which are formed in one piece with the shaft 11. The shaft 11 and the raised structures 101 are produced by means of 3D printing. In this embodiment, the element consists of a first material component. An individual design of surfaces is possible as a result of the 3D printing process. Variants in form and height of the raised structures are made possible and can easily be implemented. Individual configurations and/or motifs can be sent in digital form as so-called STL files to the 3D printer.

FIG. 2 shows a longitudinal section through the shaft 11 of FIG. 1. In FIG. 2 it can be clearly seen that shaft 11 and raised structures 101 are formed in one piece from the first material component. The element 10 has a thread 112 which forms a connecting member with another element.

FIG. 3 shows a shaft 11 as main body with raised structures 101 on the surface thereof, wherein the raised structures 101 are formed from a second material component. The second material component in this embodiment differs in color and composition from the first material component of the main body/shaft 11. The structure 101 can be formed either on the surface 111 or in an indentation 102 of the shaft 11.

FIG. 4 shows another embodiment of an element 10 in the form of a shaft 11 as main body. This shaft 11 has a recess/opening 104 and an indentation 102, wherein the indentation 102 is filled with a second material component. The filled indentation 102 terminates flat or flush with the surface 111 of the shaft 11 and thereby acts as a pure decoration or decorated region 103. The second material component is a rubber-elastic material so that in this design the decoration 103 acts as a haptic zone with a particular effect. A circumferential ring structure 105 is further shown in FIG. 4 formed from a second material component which differs in color and/or composition from the first material component of the shaft 11. Such ring structures 105 are particularly easy and simple to implement by means of 3D printing and appear on the finished product as a pure decoration of the surface even when these ring structures extend, for example, over the entire cross-section.

Here it should be noted that in FIGS. 1 to 4, for example a shaft has been selected as element for the use according to the invention. A representation/description on closure caps, clips, tubing plugs, grip zones, end stoppers and/or other elements of writing devices could also be accomplished.

The method for producing elements for the use according to the invention is described for example of scan LED technology (SLT). The following essential steps are listed here.
Step 1: converting a 3-D geometry into a so-called STL file (=surface tessalation language)
Step 2: transferring the STL file to a printer
Step 3: software of the printer positions the geometry to be printed in the installation space of the printer
Step 4: fixing the support geometry
Step 5: fixing the positioning/position of the product to be printed
Step 6: specifying the resolution of the printer—depending on the geometry to be printed
Step 7: initiating the printing process, for example with so-called Fotomed materials (UV curing) as printing media
Step 8: remove printed object from installation space
Step 9: manual removal of the support geometry
Step 10: possible manual removal of excess material

In addition to the said method of the scan LED process, the 3D printing can also be accomplished by other generative fabrication processes. For example, mention may be made of multijet modelling, selective laser sintering, polyjet technology, stereo-lithography, vacuum casting, or fused deposition modelling (FDM).

Various materials can be used for the 3D printing. For example, mention may be made of PLA, ABS, Nylon, rubber-like materials, resins and PP. For example, biocompatible materials can be used. Depending on the type of printer or the different 3D printing processes, there are material recommendations by the manufacturer and/or supplier.

### REFERENCE LIST

1 Writing, drawing, marking and/or painting device or cosmetic device or input device for touch-sensitive surfaces

10 Element

101 Raised structure

102 Indentation

103 Decorated region

104 Recesses

105 Ring structure

11 Main body

111 Surface

112 Thread

1-7. (canceled)

8. An element for writing, drawing, marking and/or painting devices or cosmetic devices or input devices for touch-sensitive surfaces, wherein the element is a 3D-printed element that comprises:
a main body; and
at least one structure, wherein the main body consists of a first material component, wherein the at least one structure is provided as a visually detectable structure and/or as at least one structure formed as a haptic zone,
wherein the at least one visually detectable structure and/or the at least one structure formed as a haptic zone is an indentation or recess in a surface of the main body, or
wherein at least one visually detectable structure and/or the at least one structure formed as a haptic zone is a raised structure that projects from the surface of the main body, or
wherein the at least one visually detectable structure and/or the least one structure formed as a haptic zone is a decorated region of the surface of the main body.

9. The element according to claim 8, wherein the raised structure and/or the decorated region is formed in one piece with the main body and the main body and the structure consist of the first material component.

10. The element according to claim 8, wherein the raised structure and/or the decorated region is formed from a second material component.

11. The element according to claim 10, wherein the second material component is configured differently in color and/or composition compared with the first material component of the main body.

12. The element according to claim 8, wherein the first material component is selected from the group consisting of: PLA, ABS, Nylon, rubber-like materials, resins and PP.

13. The element according to claim 10, wherein the second material component is selected from the group consisting of: PLA, ABS, Nylon, rubber-like materials, resins and PP.

14. A method for producing an element according to claim 1, comprising the steps of:
Step 1: converting a 3-D geometry into an STL file;
Step 2: transferring the STL file to a printer;
Step 3: using software of the printer, positioning the geometry to be printed in an installation space of the printer;
Step 4: fixing a support geometry;
Step 5: fixing a position of the element to be printed;
Step 6: specifying a resolution of the printer, depending on the geometry to be printed;
Step 7: initiating printing;
Step 8: removing the printed element from the installation space; and
Step 9: manually removing the support geometry.

15. The element according to claim 14, wherein Step 7 includes printing with UV curing materials as printing media.
